(19) United States
(12) Patent Application Publication
(10) Pub. No.: US 2006/0155978 A1
(43) Pub. Date: Jul. 13, 2006

(54) Method for initialising programmable systems

(76) Inventors: Jens David, Dresden (DE); Jens Bretschneider, Dresden (DE)

Correspondence Address: BAKER & BOTTS, 30 ROCKEFELLER PLAZA, 44TH FLOOR, NEW YORK, NY, 10112, US

(21) Appl. No.: 10/525,688

(22) PCT Filed: May 28, 2003
(86) PCT No.: PCT/DE03/01747

§ 371 Date: Jul. 27, 2005

(30) Foreign Application Priority Data
Aug. 30, 2002 (DE) 102-40-770.3

(51) Int. Cl. G06F 9/24

(52) U.S. Cl. 713/2

(57) ABSTRACT

The invention relates to a method for initialising programmable systems, whereby the information necessary for initialising registers and internal and/or external components is held in an external memory and read out. The aim of the invention is a method whereby all registers and components may be initialised, a flexible initialisation of the external electronics is possible, the ASIC development is simplified and various types of EEPROM are supported. Said aim is achieved, whereby, after switching on, or after another event causing a new start, a transfer of initialisation information is carried out from an external or internal non-volatile memory to an internal memory, controlled by a programme from an instruction memory, the initialisation information comprises initialisation data and/or at least one initialisation programme, the initialisation of the register and components occurs under the control of one or more processor elements or the intelligent components arranged in the system, which, for their part, are controlled by the initialisation programme.

### CROSS REFERENCE TO RELATED APPLICATIONS

This application claims the benefit of International Patent Application No. PCT/DE2003/001747 filed May 28, 2003, which claims priority to German Patent Application No. 102 40 770.3 filed Aug. 30, 2002, both of which applications are hereby incorporated by reference in their entireties herein.

### FIELD OF THE INVENTION

The invention relates to the operation of programming devices or systems such as computers, processors and microprocessors. In particular, the invention relates to methods for initializing such devices and systems for operation.

### BACKGROUND OF THE INVENTION

The initializing processes of programmable systems, for example, at power-up or start-up, involve initialization, resetting, or loading of registers and internal and/or external modules with start-up information. The relevant start-up information is often stored in an external memory and is read from the external memory at start-up, particularly in applications that involve programmable system-on-chip elements (e.g., Application Specific Integrated Circuits, “ASIC”).

Complex microcontroller-assisted electronic systems which use, for example, peripheral devices to a personal computer (“PC”) or the like, are usually made up of a limited number of components for production-related and economic reasons. Generally, attempts are made to accommodate all of the logic on one application-specific integrated chip or ASIC. This ASIC contains the interfaces which set up the connection to the PC, for example PCI (Peripheral Components Interconnect), Card bus controller or USB (Universal Serial Bus) controller. The nature of the products, which are produced in large quantities at low prices, means that it is usual for semiconductor design companies to develop a hard-wired solution which is produced by parties to an agreement and is sold to OEM (Original Equipment Manufacturer) customers, who integrate the semiconductors in their peripheral devices. In this case, the resultant end products usually differ in terms of scope of functions, performance, power consumption and price, depending on what circuitry and additional components have been used for the respective solution.

These differences in circuitry mean that the various hardware devices need to be addressed and handled differently in terms of software. Operating-system drivers adapted thereto are required and are often also desired by the OEM customers in order to distinguish themselves more from competitors' products as a result.

In addition, the additional electronics on the board need to be put into an initial state in various ways when they are actually turned on or plugged in.

Two problem situations arise from the demands described:

Firstly, identification needs to be performed for each external device and an appropriate device driver needs to be allocated. Modern PC operating systems need to be able to identify external modules added during operation (e.g. USB, Card bus) or before operation (e.g. PCI) automatically and to be able to allocate a suitable driver. If the features which the operating system can use for identification are accommodated exclusively on the ASIC, however, then distinction between various OEM products is not possible.

Secondly, the OEM-specific elements need to be initialized when turning on. A situation may arise in which the external electronics modules located on the device beside the ASIC need to be put into a defined initial state directly upon turning on or plugging in or within a very short time afterwards, for example in order to avoid destruction, excessive power consumption or confusing status displays, by light-emitting diodes or a display. Since the ASIC is usually the only “intelligent” chip in the circuit which can perform this task, but the external circuitry generally differs, as described above, it is necessary to find a way of letting the ASIC have the information about the initialization of the other modules so that it can perform the initialization accordingly.

Known methods are based on accommodating a small EEPROM (Electrically Erasable Programmable Read Only Memory) on the device's board and connecting it to the ASIC usually via a serial bus. The EEPROM stores identification features and serial numbers. In the case of a PCI/Card bus, for example, the identification features are understood to mean the product ID, vendor ID, subsystem ID and subsystem vendor ID as a revision identifier and device class. An example of a serial number is the MAC-ID in the case of Ethernet-network cards.

This OEM-specific information is read from the EEPROM by means of hardware logic, and is transferred to the appropriate registers in the ASIC's PCI/USB core, when the device is turned on by the end consumer. This allows the device to be identified by the computer.

The registers in the IO blocks which are used to control the rest of the electronics on the device either remain uninitialized, are set to a reset value which has been permanently “burnt in” in the ASIC, or can be set by the hardware logic according to the EEPROM content.

This known solution at least two drawbacks, which are described in more detail below.

First, the hardware required for this is relatively complex. The logic needs to be implemented in the ASIC in hard-wired form. Especially with complicated bus protocols, such as I²C, verification and implementation of the logic (additional gates, transistors, surface area on the silicon die) are complex.

Secondly, the existing method is not flexible. During the actual chip design phase, it is necessary to define which registers in the ASIC (address) need to be written to (initialized) at what time and with what content (data item) from the EEPROM. The logic described above needs to be designed in line with these requirements.

Consideration is now being given to ways of improving initialization methods and systems. In particular, attention is directed to procedures for initializing all registers and modules and to flexible initialization of the external electronics. Desired procedures will simplify ASIC design and development, and allow different external and internal storage media to be supported.

### SUMMARY OF THE INVENTION

In accordance with the principles of the invention, and procedures are provided for initializing programmable systems. The inventive procedures may be particularly advantageous for use in a system in which information required for initializing registers, internal modules and external modules is stored in external memory (or internal non-volatile storage medium). The initialization information is read from storage in response to turn-on or another event which triggers a fresh start, controlled by a program in an instruction memory. The read initialization information is transferred from the external and/or internal non-volatile storage medium to an internal memory. The initialization information contains initialization data and/or at least one initialization program, which controls one or more processor elements or other intelligent building blocks that are suitably arranged in the system. These processor elements or other intelligent building blocks are in turn configured to control the initialization of the registers and modules.

In operation, the registers and modules are initialized by one or more processor elements. This initializing processor element(s) requires a program for execution after the programming system (or device) has been turned on or after an external restart event for it. The program for starting the initialization phase is contained in an “instruction memory” (bootstrap loader). This program controls the transmission of the initialization information, for example, from an external EEPROM to a Random Access Memory (RAM), which may be an instruction and/or data RAM. In this example, the initialization information may contain both initialization data and an initialization program. The initialization data may include identifications (ID), such as the product ID, vendor ID, subsystem vendor ID or a serial number for an Ethernet network card. The initialization program controls the processor element after the initialization information has been transmitted to the instruction RAM, and implements the initialization of the registers and modules.

In one refinement of the invention, an integrity check on the initialization information is performed after the transfer, and a program branch is carried out under the control of the result of the integrity check.

In one embodiment of the invention, upon identification of an incorrect or missing internal or external storage medium, an error routine is executed, which carries out the initialization with standard values, or fully or partially restores the content of the internal or external storage medium.

In some applications of the invention, the information may be in the form of an executable macro program and may be interpreted by the processor element. Hybrid forms comprising both methods are derivable.

When the initialization information has been transmitted to the instruction RAM, the data are subjected to an integrity check, for example by ascertaining a checksum. Depending on the result, the processor element either executes the initialization program or macro instructions just transmitted or skips to a routine for handling exceptional cases in the instruction memory. This routine programs the functionally most important registers in the ASIC such that it is at least basically possible to address the device using the respective PC interface. If a missing or incorrect storage medium has been identified in the turn-on phase, a routine for initialization with standard values is likewise executed.

In a further refinement of the invention, the initialization data are read as standard values from the storage medium, are altered by the processor element, and the altered initialization data are used for initialization.

The EEPROM stores standard values, for example, for the product ID, vendor ID, subsystem vendor ID, a serial number for an Ethernet network card, etc. These values can be used directly for initializing the registers and/or modules. Alternatively, the processor element can alter the standard values or make an alternative selection under the control of an event. From the point of view of error handling, this results in the opportunity to use the support logic to alter or restore the initialization information in the external EEPROM, with it also being possible to recalculate the checksum.

In one refined form of the invention, the initialization program for the processor element calculates initialization data and uses them for initialization. The processor element can, under the control of the initialization program, calculate initialization data, for example, on the basis of the state of a port or register.

In one embodiment of the invention, state data for peripheral components and/or internal components are taken as a basis for calculating the initialization data for said components and the data for the internal components. The execution of the initialization program may be arranged such that an initialization value is chosen or calculated on the basis of states of individual internal or external registers or modules. To this end, in a first step, for example, a register or a port is interrogated and the initialization is performed on the basis of this result after a skip to a point provided for this purpose in the program execution.

In one particular embodiment of the invention, the processor element changes to a power-saving mode following initialization. After initialization has taken place, there is the opportunity to put the processor element into a power-saving mode, from which it can be reset, for example by a signal from a PC or from a peripheral module.

In another particular embodiment of the invention, the initialization of further processor elements is started and monitored. The “initial” or “first” processor element can initialize further processors which are present in the system, which subsequently start their own initialization routines. The termination of the initialization is either reported back to the first processor, or the first processor passes control to another processor.

In a further embodiment of the invention, adaptation to various storage media is performed. The instruction memory arranged in the ASIC contains a start program for execution after the device has been turned on and implements the reading of the initialization information from the external EEPROM and the transmission to the instruction RAM. This start program contains a routine which identifies the connected storage medium and ensures that the respective necessary transmission protocol is observed.

In a further refined form of the invention, the initialization program reloads further data and/or program code from a storage medium. When a particular state or event is reached, the processor element can reload further initialization information (program code or state data).

### BRIEF DESCRIPTION OF THE DRAWINGS

Further features of the invention, its nature, and various advantages will be more apparent from the following detailed description and the accompanying drawings, wherein like reference characters represent like elements throughout, and in which:

FIG. 1 is a schematic circuit arrangement based on the prior art, and

FIG. 2 is a schematic circuit arrangement configured for implementing an initialization procedure in accordance with the principles of the present invention.

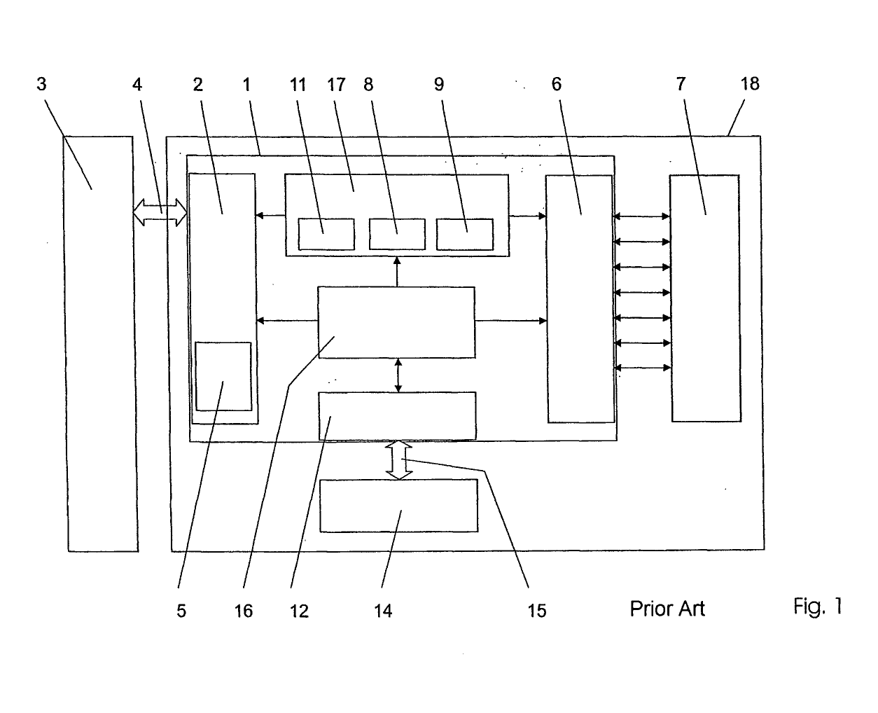

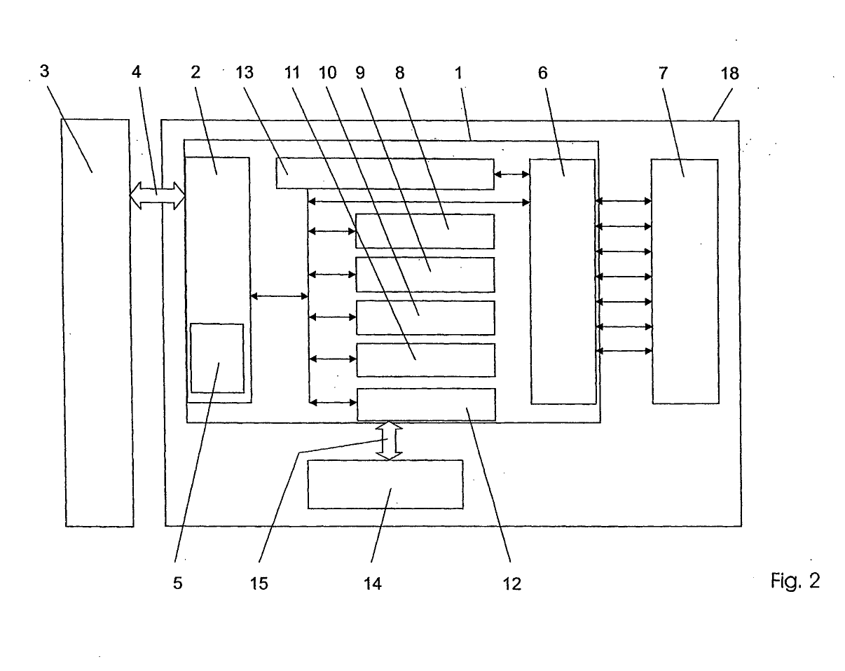

The following is a list of the reference numerals used in FIGS. 1 and 2

1 ASIC

2 Bus interface

3 Personal computer (PC)

4 First bus system

5 ID register

6 I/O interface

7 External electronics

8 Processor elements

9 Instruction memory

10 Instruction RAM

11 Data RAM

12 EEPROM interface

13 Support logic

14 Storage medium (e.g. EEPROM)

15 Second bus system

16 Initialization control

17 Primary function logic

18 Peripheral device

### DETAILED DESCRIPTION OF THE INVENTION

The present invention provides procedures for initializing devices and components of a programming system.

FIG. 2 show an exemplary ASIC-based programming system which is suitably configured so that the inventive initialization procedures and methods can be used. FIG. 1 shows, for comparison, a prior art system.

With reference to FIG. 2, to implement the inventive method, the following components were integrated in an ASIC 1: a bus interface 2 (known from the prior art), which a first bus system 4 uses to couple to a PC 3 and which contains ID registers 5 for initialization, and the I/O interface 6, which provides the coupling to the external electronics 7. Additionally, the following components are integrated in ASIC 1: a processor element 8 (which in the prior art does not necessarily have to be part of the ASIC logic 1); an instruction memory 9 (bootstrap loader); an instruction RAM 10; a data RAM 11; an EEPROM interface 12; and a support logic unit 13. The external EEPROM 14 (which may be known from the prior art) is likewise arranged outside the ASIC 1 and is connected thereto via a second bus system 15. The second bus system 15 used may, for example, be an I²C, SPI or Microwire bus. The ASIC 1, the external EEPROM 14 and the external electronics 17 form a peripheral device 18 which can be controlled by the PC 3.

Instruction memory 9 is arranged in the ASIC to contain a start program, which is to be executed after the device is turned on, and implements the reading of the initialization information from the external EEPROM 14 and the transmission to the instruction RAM 10. Since the interchange of the bus signals is dependent on the respective external EEPROM 14 and bus system 15 used and the operation is controlled by a program, the adaptation to various bus systems 15 or EEPROM types 14 can be implemented by programming. It is thus also possible to implement automatic recognition of the connected EEPROM type 14.

Exemplary instruction memory 9 may be developed using standard development and debugging tools instead of expensive special development or debugging tools.

The initialization information to be transmitted includes the initialization data and an initialization program. Following transmission of the initialization information to the instruction RAM 10, an integrity check is performed to ensure error-free transmission of the data.

If this check establishes, for example, from the checksum, that the transmission was free of errors, the continued program execution takes place using the initialization program which has just been transmitted to the instruction RAM 10. This program performs the actual initialization of the registers 5 and modules using the initialization data. By way of example, this initialization makes the necessary settings in the bus interface 2 in order to allow the communication with the PC 3 and the initialization of the other internal modules and of the I/O interface 6 for controlling the external electronics 7.

If the integrity check reveals an error, for example, because the checksum is incorrect or even no EEPROM 14 is connected, then it is possible to skip to a routine for handling exceptional cases in the instruction memory 9, said routine programming the functionally most important registers in the ASIC 1 such that the device can be addressed via the respective PC interface 4 at least in principle. This basic setting and the support logic 13 integrated in the ASIC 1 make it possible to repair a faulty device by reprogramming the EEPROM 14 with recalculation of the associated checksum or to perform the initial programming in the production facilities.

The program-controlled initialization means that it is possible to set all registers 5 or modules which can be addressed directly or indirectly by the processor element 8 and to set state machines which are dependent on said registers or modules. It is furthermore possible to perform the initialization dynamically, that is to say as a function of input values. This means that a display 7 can be used immediately in the start-up phase of the device to indicate whether or not a particular condition is met.

It will be understood that the foregoing is only illustrative of the principles of the invention, and that various modifications can be made by those skilled in the art without departing from the scope and spirit of the invention. For example, with reference to FIG. 2, the inventive method allows peripheral device 18 to act independently in order to “wake up” the PC 3 from an initial state of rest (e.g. Wake-on-LAN or Wake-up for a fax call).

1. A method for initializing programmable systems, in which the information required for initializing registers and internal and/or external modules is contained in an external memory and is read, particularly for application in programmable system-on-chip ASIC elements,
characterized in that after turn-on or another event which triggers a fresh start, controlled by a program in an instruction memory (9), initialization information is transferred from an external or internal non-volatile storage medium (14) to an internal memory (10), in that the initialization information contains initialization data and/or at least one initialization program, in that the registers (5) and modules are initialized under the control of one or more processor elements (8) or other intelligent building blocks arranged in the system, which, for their part, are controlled by the initialization program.

2. The method as claimed in claim 1,
characterized in that an integrity check on the initialization information is performed after the transfer, and in that a program branch is carried out under the control of the result of the integrity check.

3. The method as claimed in claim 1,
characterized in that, upon identification of an incorrect or missing internal or external storage medium, an error routine is executed which carries out the initialization with standard values or fully or partially restores the content of the internal or external storage medium (14).

4. The method as claimed in claim 1,
characterized in that the initialization data are read as standard values from the storage medium (14), are altered by the processor element (8), and the altered initialization data are used for initialization.

5. The method as claimed in claim 1,
characterized in that the initialization program for the processor element (8) calculates initialization data and uses them for initialization.

6. The method as claimed in claim 5,
characterized in that state data for peripheral components (7) and/or internal components are taken as a basis for calculating the initialization data for said components and the data for the internal components.

7. The method as claimed in claim 1,
characterized in that the processor element (8) changes to a power-saving mode following initialization.

8. The method as claimed in claim 1,
characterized in that the initialization of further processor elements (8) is started and monitored.

9. The method as claimed in claim 1,
characterized in that adaptation to various storage media is performed.

10. The method as claimed in claim 1,
characterized in that the initialization program reloads further data and/or program code from a storage medium (14).
